(19) United States
(12) Patent Application Publication
(10) Pub. No.: US 2024/0365216 A1
(43) Pub. Date: Oct. 31, 2024

(54) APPARATUS AND METHOD FOR TRANSMITTING AND RECEIVING DATA IN NON-TERRESTRIAL AND TERRESTRIAL NETWORK SYSTEM

(71) Applicant: Samsung Electronics Co., Ltd., Suwon-si (KR)

(72) Inventor: Nohsun KIM, Suwon-si (KR)

(21) Appl. No.: 18/671,190

(22) Filed: May 22, 2024

Related U.S. Application Data
(63) Continuation of application No. PCT/KR2024/004916, filed on Apr. 12, 2024.

(30) Foreign Application Priority Data
Apr. 27, 2023 (KR) 10-2023-0055280
May 26, 2023 (KR) 10-2023-0068502

(51) Int. Cl. H04W 48/16

(52) U.S. Cl. CPC H04W 48/16

(57) ABSTRACT

An electronic devices includes at least one communication processor comprising processing circuitry and a memory, wherein at least one communication processor, individually and/or collectively, may be configured to: obtain a value corresponding to a cell area included in a primary synchronization signal (PSS) received from a first base station, determine that the first base station is a base station supporting a terrestrial network based on the obtained value corresponding to the cell area being included in a first range, and determine that the first base station is a base station supporting a non-terrestrial network based on the value corresponding to the cell area not being included in the first range.

### CROSS-REFERENCE TO RELATED APPLICATIONS

This application is a continuation of International Application No. PCT/KR2024/004916 designating the United States, filed on Apr. 12, 2024, in the Korean Intellectual Property Receiving Office and claiming priority to Korean Patent Application Nos. 10-2023-0055280, filed on Apr. 27, 2023, and 10-2023-0068502, filed on May 26, 2023, in the Korean Intellectual Property Office, the disclosures of each of which are incorporated by reference herein in their entireties.

### BACKGROUND

### Field

The disclosure relates to an electronic device, for example, an electronic device and method for transmitting and receiving data in non-terrestrial and terrestrial network systems.

### Description of Related Art

In standards (e.g., 3GPP), in addition to communication services through terrestrial networks (TNs), standardization is underway to enable services on various electronic devices (e.g., terminals, wearable devices) through non-terrestrial networks based on NR/LTE (NB-IOT).

Non-terrestrial networks can provide relatively wide service coverage compared to terrestrial networks through stationary satellites or satellites with various heights and corresponding moving speeds, such as GEO, MEO, and LEO. Satellites are divided into GEO and LEO depending on their altitude. LEO is usually located at an altitude of 300 km to 2000 km, GEO may be located at 35786 km, and MEO may be located between LEO and GEO. In addition, in the case of LEO, the orbital period varies depending on altitude, but may be 85 to 127 minutes.

Since satellites are located in space or aviation, they can overcome vulnerabilities caused by physical attacks or natural disasters compared to TN networks.

In addition, users in suburban, rural areas, or underdeveloped countries where services are vulnerable because it is not easy to install existing terrestrial networks (e.g. LTE/NR networks) can also receive services through satellites without installing their own infrastructure.

Due to the advantages of satellite services, many satellite operators and network operators have recently rushed to introduce satellites. With the introduction of satellites, there are areas where existing terrestrial networks and non-terrestrial networks are mixed, so it is necessary to distinguish between the respective networks.

In case where an electronic device uses satellite communication, which is a non-terrestrial network, it may experience delays depending on the altitude of the satellite. In case where the electronic device uses satellite communication, which is a non-terrestrial network, the time in which the electronic device can receive service from one satellite is limited due to the satellite moving at a high speed. Because the time available for service from the satellite is limited, the electronic device may be disconnected from non-terrestrial networks and connected to terrestrial networks. The operation of connecting to a non-terrestrial network and then reconnecting to a terrestrial network may consume more current, compared to the operation of connecting directly to a terrestrial network. The electronic devices can reduce current consumption by connecting directly to a terrestrial network rather than a non-terrestrial network.

The electronic device may decode the signal received from a cell (or base station) to determine whether the searched cell supports the frequency band of a terrestrial network or non-terrestrial network. However, as described in FIGS. 5A and 5B below, the process of decoding the received signal may be time-consuming. Decoding of signals received from the cell may cause delays, and it may be difficult for the electronic device to provide uninterrupted service to users.

### SUMMARY

An electronic device, according to an example embodiment may comprises: at least one communication processor, comprising processing circuitry, and a memory, wherein at least one communication processor, individually and/or collectively, may be configured to: obtain a value corresponding to a cell area included in a primary synchronization signal (PSS) received from a first base station, determine that the first base station is a base station supporting a terrestrial network based on the obtained value corresponding to the cell area being included in a first range, and determine that the first base station is a base station supporting a non-terrestrial network based on the value corresponding to the cell area being not included in the first range.

A method for transceiving data by an electronic device, according to an example embodiment, may comprise: obtaining a value corresponding to a cell area included in a primary synchronization signal (PSS) received from a first base station, determining that the first base station is a base station supporting a terrestrial network based on the obtained value corresponding to the cell area being included in a first range, and determining that the first base station is a base station supporting a non-terrestrial network based on the value corresponding to the cell area being not included in the first range.

The electronic device according to various example embodiments of the disclosure may shorten the process of decoding a signal received from a cell (or base station) and quickly search for a network to which a connection is desired in a situation where non-terrestrial networks and terrestrial networks are mixed.

The electronic device according to various embodiments of the disclosure may quickly determine the network type (e.g., non-terrestrial network and terrestrial network) and provide uninterrupted services to users.

The effects that can be obtained from the disclosure are not limited to the effects mentioned above, and other effects not mentioned can be clearly understood by those skilled in the art from the description below.

### BRIEF DESCRIPTION OF THE DRAWINGS

FIG. 1 is a block diagram of an example electronic device in a network environment, according to various embodiments;

FIG. 2 is a diagram including a block diagram illustrating an example configuration of an electronic device and illustrating an electronic device and a long-distance communication network environment according to various embodiments;

FIG. 3 is a diagram illustrating example connection of an electronic device according to various embodiments;

FIG. 4 is a diagram illustrating example non-terrestrial network system according to various embodiments;

FIG. 5A is a block diagram illustrating an example operation of a transmitting device for a primary synchronization signal (PSS) and secondary synchronization signal (SSS) in a new radio (NR) system according to various embodiments;

FIG. 5B is a block diagram illustrating an example operation of a receiving device for cell ID detection in a new radio (NR) system according to various embodiments;

FIG. 6 is a flowchart illustrating an example method for searching for a terrestrial network by an electronic device according to various embodiments;

FIG. 7 is a flowchart illustrating an example method for searching for a non-terrestrial network by an electronic device according to various embodiments.

FIG. 8 is a flowchart illustrating an example method for transceiving data by an electronic device according to various embodiments.

### DETAILED DESCRIPTION

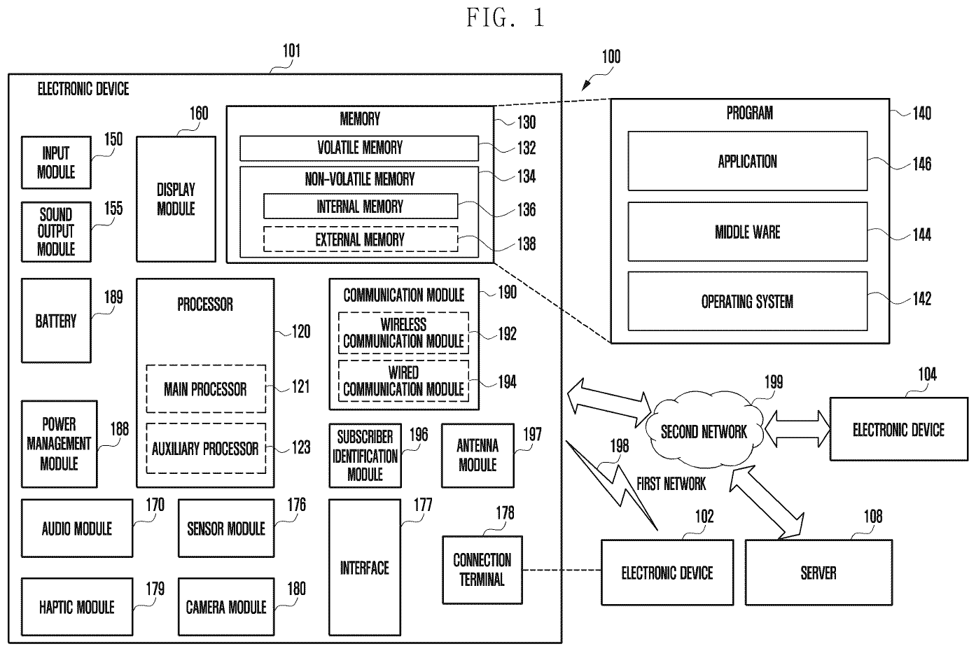

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

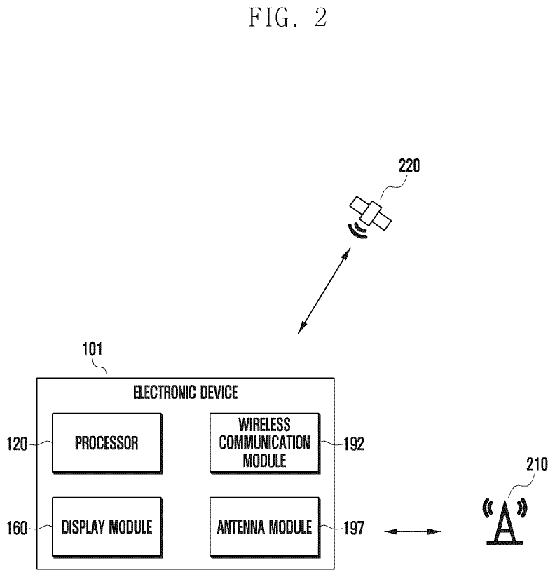

FIG. 2 is a diagram including a block diagram illustrating an example configuration of an electronic device and illustrating an electronic device and a long-distance communication network environment according to various embodiments.

According to an embodiment, the electronic device 101 may transmit and/or receive data through a terrestrial network and/or non-terrestrial network. The electronic device 101 may be the same as or similar to the configuration of the electronic device illustrated in FIG. 1 or may include the configuration of the electronic device illustrated in FIG. 1.

According to an embodiment, a terrestrial network may refer to a network that can provide data communication through a terrestrial wireless communication device 210. For example, the terrestrial wireless communication device 210 may include a base station located on the ground (e.g., a base station fixed to the ground). The terrestrial wireless communication device 210 may support at least one communication scheme among various communication schemes that the electronic device 101 can support. For example, the terrestrial wireless communication device 210 may include an eNodeB or a gNodeB, but there is no limitation on its type.

According to an embodiment, a non-terrestrial network may refer to a network capable of providing data communication through at least one non-terrestrial wireless communication device 220. For example, the non-terrestrial wireless communication device 220 may include at least one of various communication devices such as a base station and repeater that are not located on the ground. For example, the non-terrestrial wireless communication device 220 may include a satellite and/or an unmanned aerial vehicle, but the type is not limited thereto.

For example, satellites may include a low-earth orbit (LEO) satellite, a medium-earth orbit (MEO) satellite, a geostationary earth orbit (GEO) satellite, and/or a high elliptical orbit (HEO) satellite. For example, satellites may include mobile satellites and/or geostationary satellites.

According to an embodiment, the non-terrestrial wireless communication device 220 may support at least one of various wireless communication schemes. For example, the non-terrestrial wireless communication device 220 may support NR non-terrestrial network (NTN) defined by the 3rd generation partnership project (3GPP). Alternatively, the non-terrestrial wireless communication device 220 may support at least one of communication schemes based on various communication standards such as LTE, global system for mobile communications (GSM), and code-division multiple access (CDMA), but there is no limitation on the type.

According to an embodiment, the terrestrial network and the non-terrestrial network may be independent networks. The terrestrial network and the non-terrestrial network may be included in at least one network that is related to each other (e.g., a network provided by the same operator).

According to an embodiment, the electronic device 101 may perform wireless communication through a non-terrestrial network in case where the communication with a terrestrial network is not possible or is not smooth. In some cases, the electronic device 101 may perform wireless communication through a non-terrestrial network regardless of the communication status with the terrestrial network.

According to an embodiment, the electronic device 101 may include the processor (e.g., including processing circuitry) 120, the display module 160 (e.g., a display), the wireless communication module 192 (e.g., a communication circuit), and/or the antenna module (e.g., including at least one antenna) 197. For example, processor 120 may be operatively, functionally, and/or electrically connected to the display module 160, wireless communication module 192, and/or antenna module 197.

According to an embodiment, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, the instructions (e.g., a program 140 in FIG. 1) stored at least temporarily in a memory (e.g., the memory 130 in FIG. 1) to control at least one other component (e.g., a hardware or software component) of the electronic device 101 coupled with the processor 120, and may perform various data processing or computation. According to an embodiment, the processor 120 may control overall operations related to terrestrial network communications and/or non-terrestrial network communications. For example, the processor 120 may include a communication processor (e.g., the auxiliary processor 123 in FIG. 1) associated with terrestrial network communications and/or non-terrestrial network communications.

According to an embodiment, the display module 160 may include a display and visually provide information to the outside (e.g., a user) of the electronic device 101.

According to an embodiment, the display module 160 may display a UI indicating information related to a terrestrial network and/or non-terrestrial network. For example, a UI representing information related to a terrestrial network and/or non-terrestrial network may include at least one of UIs indicating information related to the type of network (e.g., cellular communication (3G, 4G, 5G), short-range communication (e.g., BT, WIFI), satellite communication), type of network service provider (e.g., a satellite communication service provider (e.g. Iridium), an emergency service provider (ESP)), network signal strength (e.g., signal strength bars, RSSI, RSRP), orientation (e.g., orientation, elevation angle, azimuth angle), presence information, and/or network communication status (e.g., idle, transmit, receive) of communication devices (satellites) included in the network.

According to an embodiment, the display module 160 may display a UI indicating services related to a terrestrial network and/or non-terrestrial network.

According to an embodiment, the services related to a terrestrial network and/or non-terrestrial network may include, for example, at least one of an emergency messaging service, a messaging service, a voice call, a video call, a data communication service, a location-related service, and/or an indicator-related service, or the like, but is not limited thereto.

According to an embodiment, the emergency messaging service may include, but is not limited thereto, at least one of an SOS service status information provision service (e.g., SOS service availability indication), a government office information provision service, an emergency contact information provision service, a commonly used phrase provision service that minimizes and/or reduces the user's text input, and a service in the form of questionnaires to quickly communicate emergency situations (e.g., type of accident, area of injury, medical information (e.g., age, gender, disease information, medication information) options provided).

According to an embodiment, the messaging service may include, but is not limited to, at least one of a small message service (SMS), a multimedia messaging service (MMS), and a rich communication suite (RCS) message.

According to an embodiment, the data communication service may include a service through various applications (e.g., web browsers) that provide data communication.

According to an embodiment, the location-related service may include, but is not limited to, at least one of longitude/latitude coordinates, map information related to the location of the non-terrestrial communication device 220, navigation, and street view.

According to an embodiment, the example of the UIs is not limited to the mentioned example, and may be provided through another output device (e.g., the sound output module 155 in FIG. 1).

According to an embodiment, the wireless communication module 192 may include various communication circuitry and support various types of wireless communication bands supported by the electronic device 101. For example, the wireless communication bands supported by the electronic device 101 may include a short-range wireless communication band (e.g., BT, Wifi), a terrestrial network (e.g., a cellular network) communication band, and/or a non-terrestrial network band, but is not limited to thereto.

According to an embodiment, the electronic device 101 may support a frequency band (e.g., n255, n256) related to non-terrestrial network wireless communication. The electronic device 101 may perform non-terrestrial network wireless communication using a frequency band related to non-terrestrial network wireless communication, but is not limited thereto. For example, the electronic device 101 may perform non-terrestrial network wireless communication using at least a portion of the frequency band associated with terrestrial network wireless communication.

According to an embodiment, the antenna module 197 may transmit or receive signals or power to the outside (e.g., an external electronic device).

According to an embodiment, the electronic device 101 may perform wireless communication with a non-terrestrial network using at least one antenna among the plurality of antennas included in the antenna module 197. At least one antenna supporting non-terrestrial wireless communication may include a dedicated antenna and/or a dual-use antenna. The dedicated antenna may include an antenna that supports a non-terrestrial network. The dual-purpose antenna may include an antenna that supports both different types of networks and a non-terrestrial network. For example, the electronic device 101 may communicate with at least one satellite (e.g., a GNSS satellite, a satellite for emergency message service) using at least one non-terrestrial network dedicated antenna. For example, the dual-purpose antenna may include an antenna that supports a short-range communication network (e.g., a Bluetooth network, a Wifi network) and/or terrestrial network (e.g., a long term evolution (LTE) network). The electronic device 101 may support a non-terrestrial network using a plurality of antennas among the antennas that support a terrestrial network.

Hereinafter, in the disclosure, a satellite may, for example, be referred to as the non-terrestrial wireless communication device 220, and although a satellite is referred to as providing wireless communication based on a specific radio access technology (RAT) (e.g., LTE) or a specific function (e.g., a base station), this is only an example and is not limited to the type.

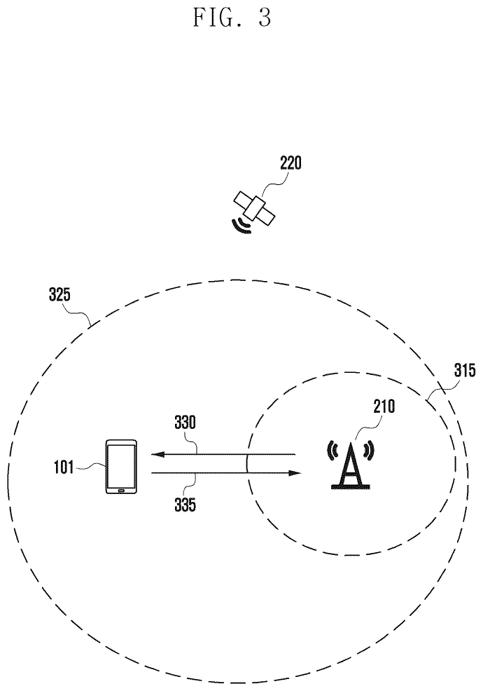

FIG. 3 is a diagram illustrating example connection of an electronic device according to various embodiments.

According to an embodiment, the electronic device 101 may be located within a coverage 315 of the terrestrial wireless communication device 210 (hereinafter referred to as a terrestrial wireless communication coverage 315) and/or a coverage 325 of the non-terrestrial wireless communication device 220 (hereinafter referred to as a non-terrestrial wireless communication coverage 325). The non-terrestrial wireless communication coverage 325 may be relatively large (e.g., 50 times or more large) compared to the terrestrial wireless communication coverage 315. For example, the non-terrestrial wireless communication coverage 325 may cover an area that the coverage 315 of the terrestrial wireless communication device 210 does not cover, and accordingly, the electronic device 101 may perform communication even in an area where terrestrial wireless communication is not supported.

According to an embodiment, the electronic device 101 may perform cell scan within the terrestrial wireless communication coverage 315 and/or non-terrestrial wireless communication coverage 325. As a result of performing a cell scan, the electronic device 101 may identify the cell provided by the terrestrial wireless communication device 210 and/or cell provided by the non-terrestrial wireless communication device 220. In case where there is a cell that satisfies a cell selection condition, the electronic device 101 may perform at least some of the operations for connecting to a network (e.g., a non-terrestrial network and/or terrestrial network). Connection to the network may include, for example, at least some of preceding operations for registration into the network (e.g., a camp-on, a connection procedure (e.g., a random access (RA) procedure)) and/or registration operations into the network (e.g., attach, registration), but is not limited thereto. In case where disconnection from the network is necessary (e.g., movement to another network), the electronic device 101 may perform at least some of disconnection operations. The disconnect operation from the network may include at least some of detach from the network, disconnection, and/or RLF declaration, but is not limited to the listed operations.

According to an embodiment, the electronic device 101 may perform at least some operations of cell scanning, disconnection from the network, and/or connection to the network according to movements 330 and 335.

According to an embodiment, in case where the electronic device 101 is located inside the terrestrial communication coverage 315 included in the non-terrestrial wireless communication coverage 325 or is located in a border area of the terrestrial communication coverage 315, the electronic device 101 may perform connection to a terrestrial network and/or non-terrestrial network based on a policy (e.g., priority policy) of the electronic device 101.

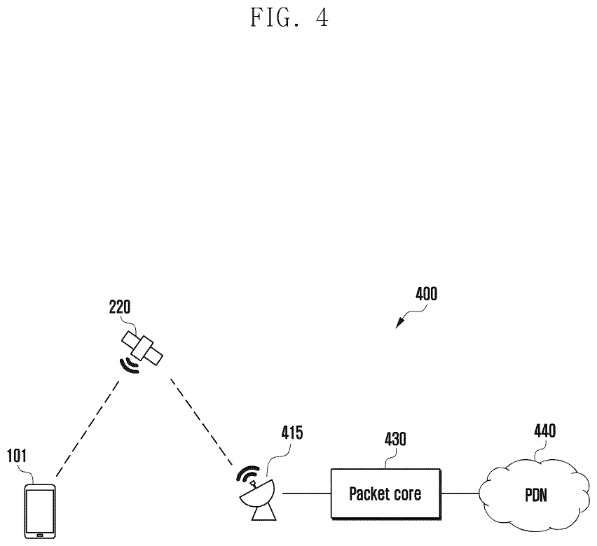

FIG. 4 is a diagram illustrating an example non-terrestrial network system 400 according to various embodiments.

With reference to FIG. 4, a non-terrestrial network system 400 according to an embodiment may include a non-terrestrial wireless communication device 220, a radio unit (e.g., including radio circuitry) 415, and a packet core 430.

According to an embodiment, the non-terrestrial network system 400 may be implemented, for example, in a regenerative scheme. In case of being implemented in a regenerative scheme, at least one non-terrestrial wireless communication device 220 may include a base station (e.g., an eNode B). The non-terrestrial network system 400 may be implemented, for example, in a bent-pipe scheme. The bent-pipe scheme may include a passive relay scheme that performs frequency conversion and power amplification on a received signal. In a case where the non-terrestrial network system 400 is implemented in the bent-pipe scheme, at least one non-terrestrial wireless communication device 220 may include a repeater that converts (e.g., amplifies) a signal and transmits it. The implementation scheme of the non-terrestrial network system 400 illustrated in FIG. 4 and the role of the non-terrestrial wireless communication device 220 are only examples and are not limited thereto.

According to an embodiment, the non-terrestrial wireless communication device 220 may include at least one satellite. For example, the non-terrestrial wireless communication device 220 may perform communication with the electronic device 101 using a terrestrial network (e.g., a cellular network) band and/or non-terrestrial network band. The terrestrial network band may be, for example, an operating band supported by long term evolution (LTE) and/or new radio (NR), but is not limited thereto. The non-terrestrial network bands may include, but are not limited to, bands defined by 3GPP (e.g., n255 bands and/or n256 bands).

According to an embodiment, at least one radio unit 415 may receive a signal from the non-terrestrial wireless communication device 220 and transmit it to the packet core 430. The radio unit 415 and the non-terrestrial wireless communication device 220 may perform communication using, for example, a non-terrestrial network band. The non-terrestrial network band may be different from the terrestrial network band, but may be set to be the same in some cases.

According to an embodiment, at least one packet core 430 may transmit and receive data associated with the electronic device 101 using the radio unit 415. Accordingly, the packet core 430 may process the data associated with the electronic device 101 and transmit it to a packet data network (PDN) 440 (e.g., the Internet). The packet core 415 may include, but is not limited to, at least some of, for example, an evolved packet core (EPC) and/or a 5G core (5GC). The packet core 430 may include the packet core associated with the operator of the non-terrestrial wireless communication device 220 and/or packet core associated with a mobile network operator (MNO). The packet core 430 may be additionally connected to a public switched telephone network (PSTN) (not shown) to transmit and receive the data associated with the electronic device 101.

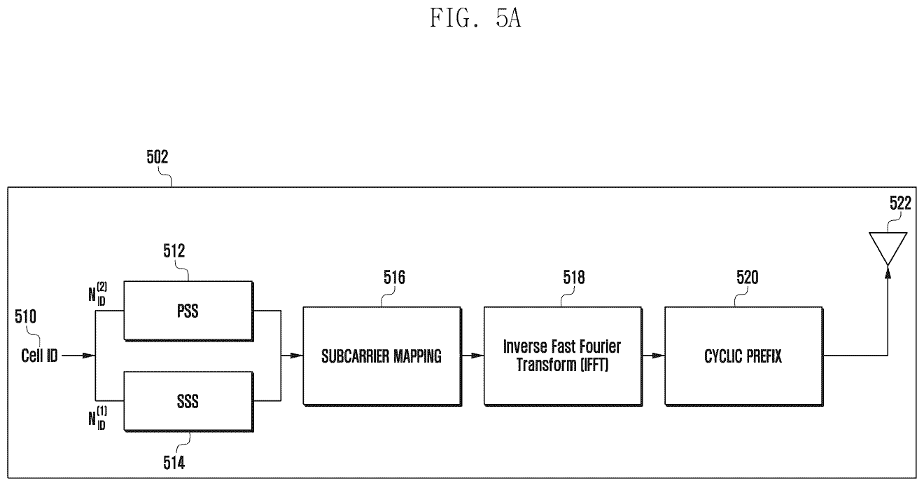

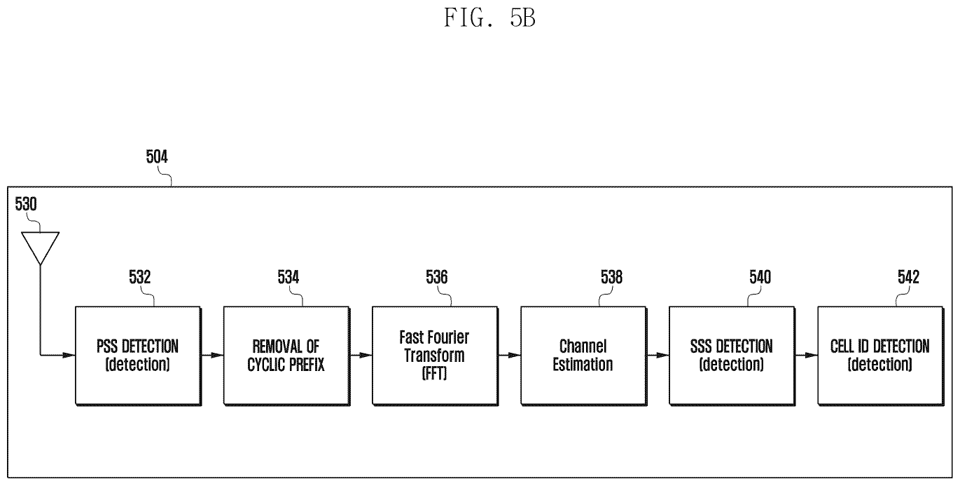

FIG. 5A is a block diagram illustrating an example operation of a transmitting device for a primary synchronization signal (PSS) and secondary synchronization signal (SSS) in a new radio (NR) system according to various embodiments.

According to FIG. 5A, the processor of the transmitting device (e.g., a base station) 502 may transmit information 510 including a cell ID using a transmitting antenna 522. The information 510 including a cell ID may include information about a cell area and/or information about ID within a cell area. The processor of the transmitting device 502 may include information about a cell area Np in a primary synchronization signal (PSS) 512. The processor of the transmitting device 502 may include information about the ID within a cell area N_{ID}⁽¹⁾ in a secondary synchronization signal (SSS) 514.

The processor of the transmitting device 502 may perform subcarrier mapping for the PSS 512 and SSS 514 in operation 516 and perform an inverse fast Fourier transform (IFFT) in operation 518. In operation 520, the processor of the transmitting device 502 may insert a cyclic prefix into the IFFT signal and transmit it to the transmitting antenna 522. The processor of the transmitting device 502 may transmit a signal including the information 510 including the cell ID to a receiver using the transmitting antenna 522.

FIG. 5B is a block diagram illustrating an example operation of a receiving device for cell ID detection in a new radio (NR) system according to various embodiments.

A receiving device 504 (e.g., a terminal, the electronic device 101 in FIG. 1) may receive a signal including the cell ID 510 using a receiving antenna 530. The processor of the receiving device 504 may perform primary synchronization signal (PSS) decoding on a signal including the cell ID 510 and detect the PSS in operation 532. The processor of the receiving device 504 may detect information about a cell area N_{ID}⁽²⁾ using the PSS. The processor of the receiving device 504 may remove the cyclic prefix in operation 534. The processor of the receiving device 504 may perform a fast Fourier transform (FFT) on the received signal in operation 536. The processor of the receiving device 504 may perform channel estimation in operation 538. The channel estimation may refer to the process of restoring a received signal by compensating for signal distortion caused by fading. For example, the processor of the receiving device 504 may perform secondary synchronization signal (SSS) decoding and detect the SSS in operation 540. The processor of the receiving device 504 may detect information about ID within a cell area N_{ID}⁽¹⁾ using the SSS. In operation 542, the processor of the receiving device 504 may use the information about a cell area N_{ID}⁽²⁾ included in the PSS and information about an ID within a cell area N_{ID}⁽¹⁾ included in the SSS to detect the cell ID.

According to a comparative example, the information about a cell area N_{ID}⁽²⁾ may be represented as {0,1,2}, and the information about an ID within a cell area N_{ID}⁽¹⁾ may be represented as {0,1, ˜,335}. The information about a cell area may include information about one area including a plurality of cells. The information about an ID within a cell area may include identification information of the cell included within the cell area. The 5G NR system may define 336 IDs (e.g., 0,1,˜,335) in three areas (e.g., 0,1,2). For example, the 5G NR system may define a total of 1008 cell IDs. The electronic device according to a comparative embodiment may obtain the information about an cell ID by performing PSS decoding and SSS decoding on the information including a cell area and cell ID.

However, the electronic device according to the comparative example must perform both PSS decoding and SSS decoding and all of the operations described in FIG. 5B to obtain the information about the cell ID. The electronic device according to the comparative embodiment may obtain the information about the cell ID and receive a system information block (SIB) after decoding a master information block (MIB). The electronic device according to the comparative embodiment must receive the SIB to determine whether a cell supports the frequency band of a non-terrestrial network or a cell that supports the frequency band of a terrestrial network, so it may take a long time. In case where the searched cell supports only the frequency band of the non-terrestrial network, the electronic device that wishes to connect to a terrestrial network may take a long time to establish a communication connection because it must search for another cell again.

The electronic device that transmits and receives data in the non-terrestrial and terrestrial network systems according to the disclosure may determine whether the cell supports the frequency band of the non-terrestrial network or whether the cell supports the frequency band of the terrestrial network using only the information obtained through the PSS decoding. The electronic device that transmits and receives data in the non-terrestrial and terrestrial network systems according to the disclosure determines whether the cell supports the frequency band of the terrestrial network or the frequency band of the non-terrestrial network through the PSS decoding, and thus, may establish a communication connection relatively quickly compared to the electronic device according to a comparative embodiment. Hereinafter, a process in which the electronic device determines whether a cell supports the frequency band of the non-terrestrial network or whether a cell supports the frequency band of the terrestrial network using only the information obtained through the PSS decoding will be described in greater detail with references to the FIGS.

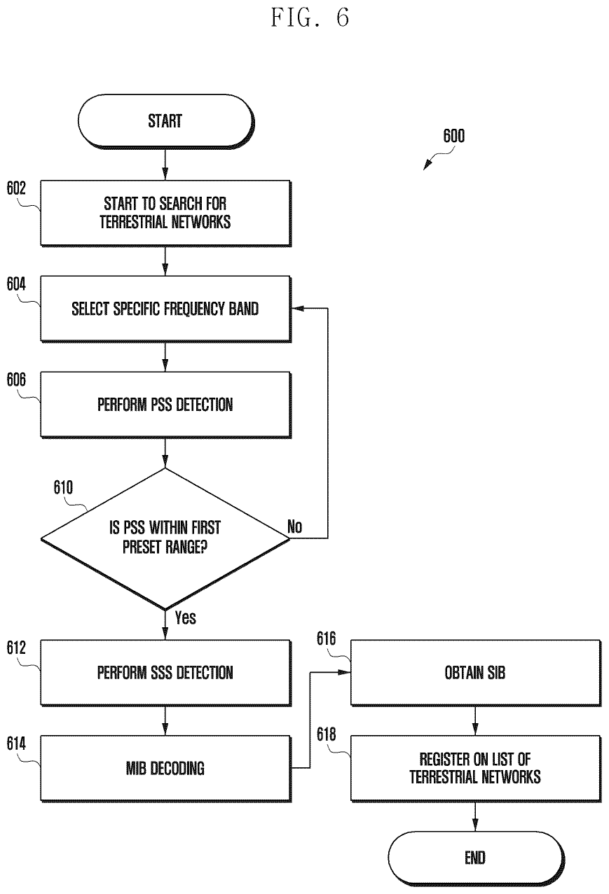

FIG. 6 is a flowchart illustrating an example method for searching for a terrestrial network by an electronic device according to an embodiment.

The operations described with reference to FIG. 6 may be implemented based on instructions that may be stored in a computer recording medium or memory (e.g., the memory 130 in FIG. 1). The illustrated method may be executed by the electronic device previously described with reference to FIGS. 1 to 5B (e.g., the electronic device 101 in FIG. 5), and technical features described above may not be repeated below. The order of each operation in FIG. 6 may be changed, some operations may be omitted, and some operations may be performed simultaneously.

In operation 602, a processor (e.g., the processor 120 in FIG. 1 or a communication processor) may begin searching a network for the purpose of establishing a communication connection with a terrestrial network.

In operation 604, the processor 120 may select a specific frequency band and search for a cell to establish a communication connection.

In operation 606, the processor 120 may receive a signal for a detected cell and perform primary synchronization signal (PSS) detection (or decoding). A signal for a cell may include information about a cell area and ID. The signal for the cell may be included in the primary synchronization signal (PSS).

In operation 610, the processor 120 may determine whether a value corresponding to a cell area on a signal detected through the primary synchronization signal (PSS) decoding is included in a first preset (e.g., specified) range. The signal detected through the primary synchronization signal (PSS) decoding may include the information about a cell area N_{ID}⁽²⁾. The processor 120 may determine whether a specific value included in the signal detected through decoding is included in the first preset range based on the information about a cell area N_{ID}⁽²⁾. The first preset range may include, for example, {0,1,2}. The first preset range may vary depending on the setting, and may include {3,4,5} in addition to {0, 1,2}. The first preset range is not limited to thereto.

The processor 120 may not perform all of the operations 532 to 542 illustrated in FIG. 5B, but performs the PSS decoding (e.g., the PSS detection operation 532 in FIG. 5B), and may determine whether a value corresponding to a cell area on the detected signal is included in a first preset range. In case of detecting a signal by performing only the PSS decoding (e.g., the PSS detection operation 532 in FIG. 5B), a detection rate may be relatively shortened compared to the case where a signal is detected by performing all operations 532 to 542 illustrated in FIG. 5B. The processor 120 may determine that a cell, which has been detected based on a matter that a value corresponding to a cell area in the information about a cell area N_{ID}⁽²⁾ obtained by performing the PSS decoding is included in the first preset range, is a cell that supports the frequency band of the terrestrial network. For example, the first preset range may include {0,1,2}. In this case, the processor 120 may determine that a cell, which has been detected based on a matter that a value corresponding to a cell area in the information about a cell area N_{ID}⁽²⁾ includes any one of {0,1,2}, is a cell that supports the frequency band of the terrestrial network. As another example, the first preset range may include {3,4,5}. In this case, the processor 120 may determine that a cell, which has been detected based on a matter that the information about a cell area N_{ID}⁽²⁾ includes {3,4,5}, is a cell that supports the frequency band of the terrestrial network. {0,1,2} and {3,4,5} are only examples, and the first preset range may vary depending on the settings, and is not limited to thereto.

The processor 120 may determine that a cell, which has been detected based on a matter that the signal detected through the PSS decoding is included in the first preset range, is a cell that supports the frequency band of the terrestrial network.

On the other hand, the processor 120 may determine that a cell, which has been detected based on a matter that the detected signal is not included in the first preset range, is a cell that does not support the frequency band of the terrestrial network. Based on a matter that the detected signal is not included in the first preset range (operation 610-No), the processor 120 may select a specific frequency band and detect the cell signal again in operation 604.

The processor 120 may perform secondary synchronization signal (SSS) detection (or decoding) in operation 612 based on the detected signal being included in the first preset range (operation 610—Yes). The processor 120 may obtain the information about a cell ID within a specific area by performing decoding on the SSS. The processor 120 may detect a cell ID using the information about a cell area N_{ID}⁽²⁾ included in the PSS and the information about an ID within a cell area N_{ID}⁽¹⁾ included in the SSS. As explained in FIG. 5B, the information about a cell area N_{ID}⁽²⁾ may be represented as any one of {0, 1,2} values, and the information about an ID within a cell area N_{ID}⁽¹⁾ may be represented as any one of {0,1,˜,335} values.

The processor 120 may decode a master information block (MIB) in operation 614. The processor 120 may decode the master information block (MIB) and obtain (or receive) a system information block (SIB) in operation 616. SIB may include information necessary for a communication connection. For example, SIB may provide information related to public warning systems used in large-scale emergency situations. Through SIB, relevant emergency situation information may be provided to mobile users and information necessary for coping and response may be quickly delivered. The electronic device may receive SIB information and provide emergency situation information to the user. The processor 120 may use the received SIB to determine whether the searched cell supports the frequency band of a terrestrial network or the frequency band of a non-terrestrial network.

The processor 120 may register the searched cell on a list of the terrestrial network in operation 618.

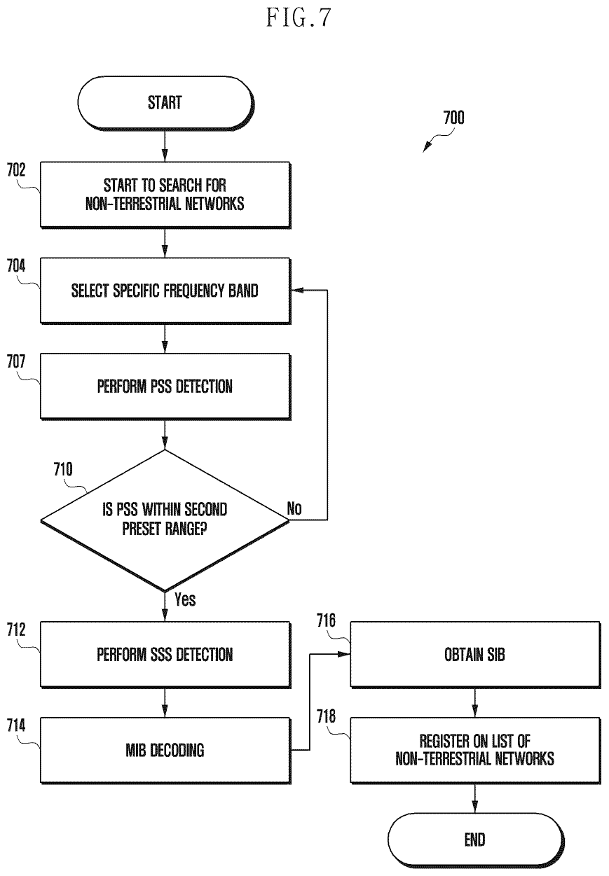

FIG. 7 is a flowchart illustrating an example method for searching for a non-terrestrial network by an electronic device according to various embodiments.

The operations described with respect to FIG. 7 may be implemented based on instructions that may be stored in a computer recording medium or memory (e.g., the memory 130 in FIG. 1). The illustrated method may be executed by the electronic device previously described with reference to FIGS. 1 to 5B (e.g., the electronic device 101 in FIG. 5), and technical features described above may not be repeated here. The order of each operation in FIG. 7 may be changed, some operations may be omitted, and some operations may be performed simultaneously.

In operation 702, a processor (e.g., the processor 120 in FIG. 1 or a communication processor) may begin searching a network for the purpose of establishing a communication connection with a non-terrestrial network.

In operation 704, the processor 120 may select a specific frequency band and search for a cell to establish a communication connection.

In operation 706, the processor 120 may receive a signal for a detected cell and perform primary synchronization signal (PSS) detection (or decoding). A signal for a cell may include information about a cell's area and ID. The signal for the cell may be included in the primary synchronization signal (PSS).

In operation 710, the processor 120 may determine whether a value corresponding to a cell area on a signal detected through the primary synchronization signal (PSS) decoding is included in a second preset range. The signal detected through the primary synchronization signal (PSS) decoding may include the information about a cell area N_{ID}⁽²⁾. The processor 120 may determine whether a value corresponding to a cell area on the signal detected through decoding based on the information about a cell area N_{ID}⁽²⁾ is included in the second preset range. The second preset range may include, for example, {0,1,2}. The second preset range may vary depending on the setting, and may include {3,4,5} in addition to {0,1,2}. The second preset range is not limited to thereto. The second preset range may be distinguished from the first range in FIG. 6.

According to an embodiment, the processor 120 may use a network type value in a master information block (MIB) to determine whether the searched cell supports the frequency band of a terrestrial network or the frequency band of a non-terrestrial network.

The processor 120 may not perform all of the operations (532 to 542) illustrated in FIG. 5B, but performs the PSS decoding (e.g., the PSS detection operation 532 in FIG. 5B), and may determine whether a value corresponding to a cell area on the detected signal is included in a second preset range. In case of detecting a signal by performing only the PSS decoding (e.g., the PSS detection operation 532 in FIG. 5B), a detection rate may be relatively shortened compared to the case where a signal is detected by performing all operations 532 to 542 illustrated in FIG. 5B. The processor 120 may determine that a cell, which has been detected based on a matter that a value corresponding to a cell area in the information about a cell area N_{ID}⁽²⁾ obtained by performing the PSS decoding is included in the second preset range, is a cell that supports the frequency band of the non-terrestrial network. For example, the second preset range may include {0,1,2}. In this case, the processor 120 may determine that a cell, which has been detected based on a matter that the information about a cell area N_{ID}⁽²⁾ corresponds to any one of {0,1,2}, is a cell that supports the frequency band of the terrestrial network. As another example, the second preset range may include {3,4,5}. In this case, the processor 120 may determine that a cell, which has been detected based on a matter that a value corresponding to a cell area in the information about a cell area N_{ID}⁽²⁾ includes any one of {3,4,5}, is a cell that supports the frequency band of the non-terrestrial network. {0,1,2} and {3,4,5} are only examples, and the second preset range may vary depending on the settings, and is not limited to thereto.

The processor 120 may determine that a cell, which has been detected based on a matter that a specific value included in the signal detected through the PSS decoding is included in the second preset range, is a cell that supports the frequency band of the non-terrestrial network.

On the other hand, the processor 120 may determine that a cell, which has been detected based on a matter that a specific value included in the detected signal is not included in the second preset range, is a cell that does not support the frequency band of the non-terrestrial network. Based on a matter that the detected signal is not included in the second preset range (operation 710—No), the processor 120 may select a specific frequency band and detect the cell signal again in operation 704.

The processor 120 may perform secondary synchronization signal (SSS) detection (or decoding) in operation 712 based on a specific value included in the detected signal being included in the second preset range (operation 710—Yes). The processor 120 may obtain the information about a cell ID within a specific area by performing decoding on the SSS. The processor 120 may detect a cell ID using the information about a cell area N_{ID}⁽²⁾ included in the PSS and the information about an ID within a cell area N_{ID}⁽¹⁾ included in the SSS. As explained in FIG. 5B, the information about a cell area N_{ID}⁽²⁾ may be represented as any one of {0,1,2} values, and the information about an ID within a cell area N_{ID}⁽¹⁾ may be represented as any one of {0, 1,˜,335} values.

The processor 120 may decode a master information block (MIB) in operation 714. The processor 120 may decode the master information block (MIB) and obtain (or receive) a system information block (SIB) in operation 616. SIB may include information necessary for a communication connection.

The processor 120 may register the searched cell on a list of non-terrestrial networks in operation 718.

According to an embodiment, the processor 120 may perform decoding based on receiving the primary synchronization signal (PSS) from a first base station, and obtain a network identification. The network identification may include the information about a cell area N_{ID}⁽²⁾ and the information about an ID within a cell area N_{ID}⁽¹⁾. The processor 120 may determine that the first base station is a base station supporting a terrestrial network based on identifying that a value corresponding to a cell area in the obtained network identification falls within the first range. The processor 120 may determine that the first base station is a base station supporting a non-terrestrial network based on a matter that a value corresponding to a cell area in the obtained network identification does not fall within the first range.

According to an embodiment, the processor 120 may perform decoding based on receiving the primary synchronization signal (PSS) from the first base station and receive the information about a cell area N_{ID}⁽²⁾ included in the PSS.

According to an embodiment, the processor 120 may acquire the information about a cell area N_{ID}⁽²⁾ included in the PSS, and determine that the signal detected based on the information about a cell area is within a first preset range.

According to an embodiment, the first range may refer, for example, to a range of values corresponding to a cell area in the information about a cell area N_{ID}⁽²⁾ included in the PSS, and may include any one of {0,1,2} and {3, 4,5}. The first range may vary depending on settings.

According to an embodiment, in case where the first range includes {0,1,2}, and the range of the information about a cell area N_{ID}⁽²⁾ included in the PSS includes {3,4,5}, the processor 120 may determine that the obtained network identification does not fall within the first range, and the first base station is a base station supporting the non-terrestrial network.

According to an embodiment, in case where the first range includes {0,1,2}, and the range of the information about a cell area N_{ID}⁽²⁾ included in the PSS includes {0,1,2}, the processor 120 may determine that the obtained network identification falls within the first range, and the first base station is a base station supporting the terrestrial network.

According to an embodiment, the processor 120 may use a network type value in a master information block (MIB) to determine whether the searched cell supports the frequency band of the terrestrial network or the frequency band of the non-terrestrial network.

The electronic device 101 may search for an appropriate cell of a selected public land mobile network (PLMN) and then stay in an RRC idle state in the corresponding cell. The electronic device 101 in the RRC idle state may select a cell that can provide available services (cell selection) and adjust to the control channel of the selected cell. This process may be referred to as “camping on a cell.” When camping on is completed, the electronic device 101 may register itself in the registration area of the selected cell. In case where the electronic device 101 leaves the cell's service area or finds a more suitable cell, the electronic device 101 may reselect and camp on the most suitable cell within the PLMN. In case where a new cell is included in a different registration area, a location registration request may be performed. In case where the electronic device 101 leaves the service area of the PLMN, a new PLMN may be automatically selected or a new PLMN may be manually selected by the user.

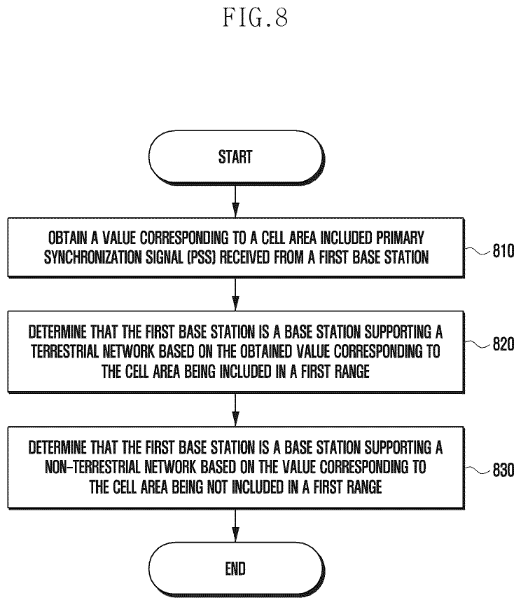

FIG. 8 is a flowchart illustrating an example method for transceiving data by an electronic device according to various embodiments.

The operations described with reference to FIG. 8 may be implemented based on instructions that may be stored in a computer recording medium or memory (e.g., the memory 130 in FIG. 1). The illustrated method may be executed by the electronic device previously described with reference to FIGS. 1 to 5B (e.g., the electronic device 101 in FIG. 5), and technical features described above may not be repeated here. The order of each operation in FIG. 8 may be changed, some operations may be omitted, and some operations may be performed simultaneously.

In operation 810, a processor (e.g., the processor 120 in FIG. 1) may obtain a value corresponding to a cell area included in the primary synchronization signal (PSS) received from the first base station. The signal detected through the primary synchronization signal (PSS) decoding may include information about a cell area N_{ID}⁽²⁾. The processor 120 may determine whether a specific value included in the signal detected through decoding based on the information about a cell area N_{ID}⁽²⁾ is included in the first preset range. The first preset range may include, for example, {0,1,2}. The first preset range may vary depending on the setting, and may include {3,4,5} in addition to {0,1,2}. The first preset range is not limited to thereto.

In operation 820, the processor 120 may determine that the first base station is a base station supporting the terrestrial network based on the value corresponding to the obtained cell area being included in the first range.

The processor 120 may determine that a cell, which has been detected based on a matter that a value corresponding to a cell area in the information about a cell area N_{ID}⁽²⁾ obtained by performing the PSS decoding is included in the first preset range, is a cell that supports the frequency band of the terrestrial network. For example, the first preset range may include {0,1,2}. In this case, the processor 120 may determine that a cell, which has been detected based on a matter that a value corresponding to a cell area in the information about a cell area N_{ID}⁽²⁾ includes any one of {0,1,2}, is a cell that supports the frequency band of the terrestrial network. As another example, the first preset range may include {3,4,5}. In this case, the processor 120 may determine that a cell, which has been detected based on a matter that the information about a cell area N_{ID}⁽²⁾ includes {3,4,5}, is a cell that supports the frequency band of the terrestrial network. {0,1,2} and {3,4,5} are only examples, and the first preset range may vary depending on the settings, and is not limited to thereto.

The processor 120 may determine that a cell, which has been detected based on a matter that the signal detected through the PSS decoding is included in the first preset range, is a cell that supports the frequency band of the terrestrial network.

In operation 830, the processor 120 may determine that the first base station is a base station that supports the non-terrestrial network based on the value corresponding to a cell area being not included in the first range.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic devices, comprising:
at least one communication processor comprising processing circuitry; and
memory storing instructions which, when executed by the at least one processor, cause the electronic device to:
obtain a value corresponding to a cell area included in a primary synchronization signal (PSS) received from a first base station, determine that the first base station is a base station supporting a terrestrial network based on the obtained value corresponding to the cell area being included in a first range, and determine that the first base station is a base station supporting a non-terrestrial network based on the value corresponding to the cell area not being included in the first range.

2. The electronic device of claim 1, wherein the instructions, when executed by the at least one processor, further cause the electronic device to: perform decoding on the PSS based on receiving the primary synchronization signal (PSS) from the first base station, and receive information about the cell area included in the PSS.

3. The electronic device of claim 2, wherein the instructions, when executed by the at least one processor, further cause the electronic device to: obtain the information about the cell area included in the PSS, and determine whether a value corresponding to the cell area included in a signal detected based on the information about the cell area is included in the first range.

4. The electronic device of claim 1, wherein the first range is a range of the information about the cell area included in the PSS.

5. The electronic device of claim 4, wherein the instructions, when executed by the at least one processor, further cause the electronic device to: determine that the first base station is the base station supporting the non-terrestrial network based on a value for the cell area in the information about the cell area included in the PSS not being included in the first range and is included in a second range different from the first range.

6. The electronic device of claim 4, wherein the instructions, when executed by the at least one processor, further cause the electronic device to: determine that the first base station is the base station supporting the terrestrial network based on a value for the cell area in the information about the cell area included in the PSS being included in the first range.

7. The electronic device of claim 1, wherein the instructions, when executed by the at least one processor, further cause the electronic device to: use a network type value in a master information block (MIB) to determine whether a searched cell supports a frequency band of the terrestrial network or a frequency band of the non-terrestrial network.

8. A method for transceiving data by an electronic device, comprising:
obtaining a value corresponding to a cell area included in a primary synchronization signal (PSS) received from a first base station;
determining that the first base station is a base station supporting a terrestrial network based on identifying that the obtained value corresponding to the cell area being included in a first range; and
determining that the first base station is a base station supporting a non-terrestrial network based on the value corresponding to the cell area not being included in the first range.

9. The method of claim 8, wherein the obtaining the value corresponding to the cell area included in the primary synchronization signal (PSS) received from the first base station further includes;
performing decoding based on receiving the primary synchronization signal (PSS) from the first base station, and
receiving information about the cell area included in the PSS.

10. The method of claim 9, further comprising:
obtaining the information about the cell area included in the PSS, and
determining whether a value corresponding to the cell area included in a signal detected based on the information about the cell area is included in the first range.

11. The method of claim 8, wherein the first range is a range of the information about the cell area included in the PSS.

12. The method of claim 11, further comprising: determining that the first base station is the base station supporting the non-terrestrial network based on a value for the cell area in the information about the cell area\included in the PSS not being included in the first range and being included in a second range different from the first range.

13. The method of claim 11, further comprising: determining that the first base station is the base station supporting the terrestrial network based on a value for the cell area in the information about the cell area included in the PSS being included in the first range.

14. The method of claim 8, further comprising: using a network type value in a master information block (MIB) to determine whether a searched cell supports a frequency band of the terrestrial network or a frequency band of the non-terrestrial network.

15. A non-transitory computer-readable recording media have recorded thereon instructions that, when executed by at least one communication processor, individually and/or collectively, causes an electronic device to perform operations comprising: obtaining a value corresponding to a cell area included in a primary synchronization signal (PSS) received from a first base station, determining that the first base station is a base station supporting a terrestrial network based on the obtained value corresponding to the cell area being included in a first range, and determining that the first base station is a base station supporting a non-terrestrial network based on the value corresponding to the cell area not being included in the first range.

16. The non-transitory computer-readable recording media of claim 15, wherein the instructions further include instructions that, when executed, cause the electronic device to: perform decoding on the PSS based on receiving the primary synchronization signal (PSS) from the first base station, and receive information about the cell area included in the PSS.

17. The non-transitory computer-readable recording media of claim 16, wherein the instructions further include instructions that, when executed, cause the electronic device to: obtain the information about the cell area included in the PSS, and determine whether a value corresponding to the cell area included in a signal detected based on the information about the cell area is included in the first range.

18. The non-transitory computer-readable recording media of claim 15, wherein the first range is a range of the information about the cell area included in the PSS.

19. The non-transitory computer-readable recording media of claim 18, wherein the instructions further include instructions that, when executed, cause the electronic device to: determine that the first base station is the base station supporting the non-terrestrial network based on a value for the cell area in the information about the cell area included in the PSS not being included in the first range and being included in a second range different from the first range.

20. The non-transitory computer-readable recording media of claim 18, wherein the instructions further include instructions that, when executed, cause the electronic device to: determine that the first base station is the base station supporting the terrestrial network based on a value for the cell area in the information about the cell area included in the PSS being included in the first range.
